(19) United States
(12) Patent Application Publication
(10) Pub. No.: US 2019/0022739 A1
(43) Pub. Date: Jan. 24, 2019

(54) Piston Having Three Ring Grooves And A Further Groove Having A Joint

(71) Applicant: KS Kolbenschmidt GmbH, Neckarsulm (DE)

(72) Inventors: Emmerich Ottliczky, Forchtenberg (DE); Matthias Fahr, Bad Friedrichshall (DE); Gregor Müller, Mannheim (DE); Ralf Stier, Neuenstadt a.K. (DE)

(21) Appl. No.: 16/070,587

(22) PCT Filed: Jan. 20, 2017
(86) PCT No.: PCT/EP2017/051241

§ 371 Date: Jul. 17, 2018

(30) Foreign Application Priority Data
Jan. 22, 2016 (DE) 10 2016 000 573.4

(51) Int. Cl. B21K 1/18

(52) U.S. Cl. CPC B21K 1/185; B23P 15/10

(57) ABSTRACT

A method for producing a cooling duct piston for an internal combustion engine having a cooling duct in its piston crown. A piston main body is produced with a collar which is circumferential and projects radially in the region of the piston crown. The collar is formed until its outer circumferential edge comes very closely or completely into contact with a bearing region of the piston lower part forming the cooling duct. At least one ring groove is introduced. A ring-free groove is further formed below the ring groove, wherein a dividing plane lies between the outer circumferential edge of the formed collar and an upper side of the piston lower part in the ring-free groove.

### TECHNICAL FIELD

The invention relates to a method for producing a cooling duct piston for an internal combustion engine, which cooling duct piston has a cooling duct in its piston crown, wherein the piston crown is adjoined by a piston lower part with piston bosses, pin bores and piston skirts, wherein a piston main body is firstly produced with a collar which is circumferential and projects radially in the region of the piston crown, wherein the collar is formed in such a manner until its outer circumferential edge comes very closely or completely into contact with a bearing region of the piston lower part, in order to form the cooling duct, and subsequently at least one ring groove is introduced.

### BACKGROUND

The present invention is based on a method for producing a cooling duct piston for an internal combustion engine and a cooling duct piston produced according to this which has a cooling duct in its piston crown, wherein the cooling duct base is adjoined by a piston lower part with piston bosses, pin bores and piston skirts, wherein a piston blank is initially produced with a collar which is circumferential and projects radially in the region of the piston crown and the collar is then formed, wherein in a transitional region between the piston crown and the piston lower part, a bearing region for the collar is formed and the collar is formed in such a manner until the outer radially circumferential edge thereof comes very closely or completely into contact with the bearing region, in order to form a closed cooling duct.

A method of this kind for producing a cooling duct piston and a cooling duct piston produced according to this is known from DE 10 2004 031 513 A1.

The cooling duct piston produced according to this has three grooves, wherein rings are inserted into these three ring grooves in a known manner so that the piston is ready for use.

FIG. 1 shows a cooling duct piston 1 produced according to the method described in DE 10 2004 031 513 A1. This cooling duct piston 1 comprises a piston main body 2, wherein the circumferential and radially projecting collar 3 is formed about roughly 90° and provided with three ring grooves 4. The circumferential outer edge of the collar 3 comes into contact with a piston lower part 5, so that a cooling duct 6 closed up to at least one intake and at least one outlet opening is thereby created. The contact between the lower circumferential edge of the formed collar 3 and the piston lower part 5 is at least partly circumferential, possibly completely circumferential, about the circumference of the cooling duct piston 1 in the region of a dividing plane 7.

With the method known in the art, the two regions adjacent to one another are welded about the dividing plane 7. Following this process, the cooling duct piston 1 is reworked, said cooling duct piston not having been ready for operation up to this point and therefore having to be brought up to the required standard, in particular through the removal of weld seams in the region of the dividing plane 7. Only once this has taken place is the cooling duct piston 1 ready for operation, so that it can be provided with further elements (in particular the insertion of rings into the ring grooves 4) and can then be fitted.

### SUMMARY

The problem addressed by the invention is that of developing the method known in the art and improving a cooling duct piston according to this method in terms of its functionality.

According to the invention, it is provided that below the at least one ring groove, in particular the lowest ring groove into which a ring is later inserted, a ring-free groove is formed, wherein a dividing plane between the outer circumferential edge of the formed collar and an upper edge of the piston lower part lies in the ring-free groove.

According to the invention, the dividing plane is therefore placed in a circumferential groove between the ring field (to be precise, the lower edge of the formed collar thereof) to the upwardly pointing end of the piston skirt, which circumferential groove is left free of a ring being inserted there. Therefore, in addition to the two, three or more ring grooves already present, into which rings are inserted, a further ring-free groove is created which is arranged below the oil ring groove which is known per se. The dividing plane (bearing region) is located with the aim that the joint can be made in the region of the additional ring-free groove and therefore a substance-bonded connection can be made between the ring field and the piston skirt, wherein the joining process advantageously takes place in a region which is free of a ring, so that after the join has been made there no machining or a small amount of machining can take place in order to remove beads from the join. Moreover, the joining plane or else the joining region lying around it is not located in a heavily loaded ring groove, which means that wear is thereby reduced and the strength of the cooling duct piston is increased. In a particularly advantageous manner, the invention is used with a piston with three grooves with rings inserted in each of them and the fourth circumferential groove in which the joining region is located is present below the lowermost ring groove (oil ring groove).

By locating the joining process in a further, in particular fourth, groove, negative effects which occur both during working (joining action during which steel fractures occur due to incompletely filled weld seams) and also in relation to the quality of the grooves (pores in the groove base, on the groove sides and the groove edge) are effectively avoided.

The invention therefore relates to a method for producing a cooling duct piston and a cooling duct piston produced according to this, in which a dividing plane is placed between the ring field and piston skirt in a circumferential groove without a ring additionally provided below the oil ring groove.

In a development of the invention, the collar is configured and formed in such a manner that in the region of the dividing plane between the outer circumferential edge of the formed collar and an upper side of the piston lower part a gap is created. Through a gap of this kind, the oil accumulating at the cylinder wall during the movement of the cooling duct piston can be removed in the direction of an inner region of the cooling duct. In addition or alternatively, cooling oil which is located in the inner region of the cooling duct piston and is injected into the cooling duct and moved out of it again can be conveyed via the gap in the direction of the cylinder wall, in order to improve friction. Via the further ring-free groove, oil can therefore be collected and removed or supplied oil conveyed in the direction of the cylinder wall. The gap may run continuously in only one plane or also in at least two or more than two different planes (preferably horizontally and vertically) from the outside of the cooling duct piston in the direction of its inner region.

In a development of the invention, the collar is configured and formed in such a manner that in the region of the dividing plane the outer circumferential edge of the formed collar comes into contact at the upper side of the piston lower part. In this way, a gap is avoided and the bearing region is therefore completely closed in the region of the dividing plane. In this way, insofar as it is necessary, oil is effectively prevented from being conveyed from the inner region of the cooling duct piston in the direction of the cylinder wall. Moreover, the accumulating effect of oil below the lowermost ring groove into which an oil ring, in particular, is inserted is thereby increased substantially through which the additional ring-free groove.

In a development of the invention, the ring-free groove is formed by a chip-removing machining process. After the initially radially projecting and circumferential collar has been formed and the cooling duct thereby created, the ring-free groove is produced below the lowermost (or single) ring groove by chip-removing machining, in particular by a puncturing process. This may take place irrespective of whether a gap is present in the region of the dividing plane or the circumferential lower edge of the collar has come into contact with the upper side of the piston lower part.

Alternatively or in addition to this, the ring-free groove is formed by non-cutting machining Through a non-cutting process of this kind (for example rolling, pressing or the like), material can be saved and the generation of chips avoided. Moreover, a non-cutting machining step of this kind has an advantageous effect on the structural conditions of the material about the gap.

Alternatively or in addition to the non-cutting or chip-removing production of the ring-free groove, said groove is created by forming the outer circumferential edge of the formed collar and an upper side of the piston lower part. On the one hand, it is conceivable for the circumferential lower edge of the collar and the corresponding region of the piston lower part to be configured in such a manner that following the forming process the ring-free groove (with or without gap in the region of the dividing plane) is created. In this way, this ring-free groove can be produced in a very simple manner If it should be necessary, particularly based on tolerances of the bearing regions involved or else based on the forming, it is on the other hand conceivable for the ring-free groove to be created not only by a corresponding shaping of the regions involved but also, in addition, through a further chip-removing machining process. The required tolerances are achieved through a chip-removing machining process of this kind, wherein at the same time due to the corresponding forming this machining process can be shortened, since less material has to be removed than if the complete ring-free groove had to be cut out.

It is therefore particularly advantageous for a development of the invention to involve the ring-free groove being created by a forming of the outer circumferential edge of the formed collar and an upper side of the piston lower part and a subsequent chip-removing machining process.

As a development of the invention, in the region of the dividing plane between the outer circumferential edge of the formed collar and an upper side of the piston lower part, a joining process is carried out. In this way, the adjacent regions can be supported against one another, which advantageously results in a uniform application of forces acting on the piston crown in the direction of the lower part of the piston.

Alternatively or in addition to a substance-bonded connection, form-fitting connections are also possible. These may, for example, be a tongue-and-groove connection, wherein a spring (projection) (for example projecting from the face of the outer circumferential edge of the circumferential collar) engages with a groove (for example present in the corresponding piston lower part) (or vice versa), when the collar has been formed. Geometries other than the tongue-and-groove geometry described are likewise conceivable.

As a development of the invention, the joining process is performed as a welding process, a soldering process, a bonding process, or the like. By means of a welding or soldering process of this kind, the adjacent regions can be permanently connected to one another quickly and in a substance-bonded and also process-reliable manner. The same applies to a bonding process by means of an adhesive which must be correspondingly temperature-resistant.

As a development of the invention, a welding bead created during the welding process is removed. This takes place either by reworking the outer surface of the blank of the cooling duct piston following the joining process and subsequent introduction of the ring-free groove (in particular through a chip-removing process) or without prior reworking of the surface of the blank of the cooling duct piston, so that a resulting welding bead is also removed at the same time by introducing the ring-free groove. The same applies to excesses that occur during the soldering process or the bonding process.

### BRIEF DESCRIPTION OF THE DRAWINGS

FIG. 1 is an example of a prior art cooling duct piston.

FIGS. 2-5 are examples of a cooling duct piston produced according to the inventive method.

### DETAILED DESCRIPTION

In terms of its production, a cooling duct piston 10 according to the exemplary embodiment is also based on the method described in DE 10 2004 031 513 A1.

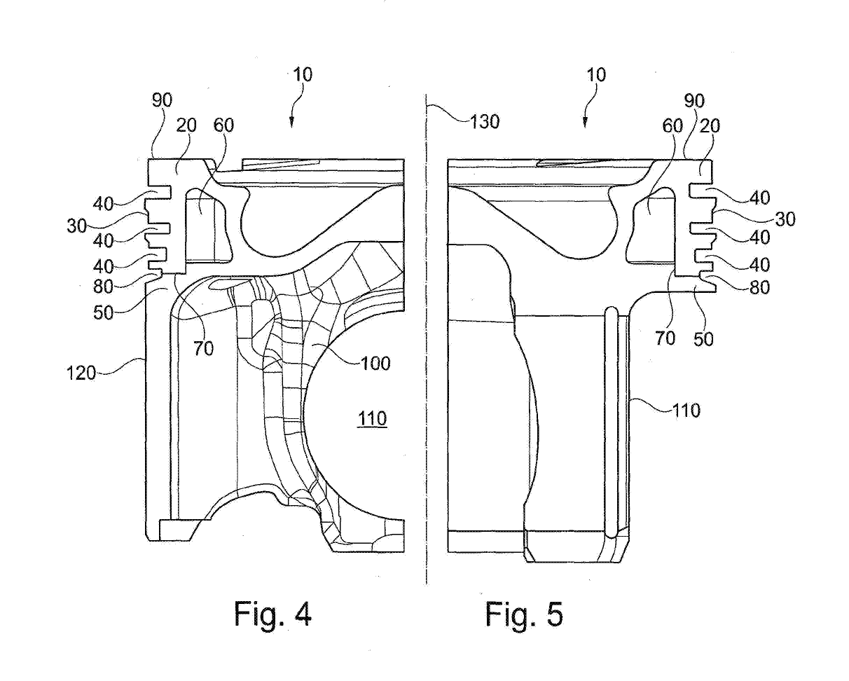

The detail of the cooling duct piston 10, as shown in FIG. 2, is also once again based on the fact that a radially projecting and circumferential collar is initially provided by a piston main body 20. In a suitable method step, this initially projecting collar is formed in such a manner that from its initial orientation projecting roughly perpendicularly to the piston stroke axis it is formed in a roughly parallel orientation in relation thereto. The collar is thereby “folded down” at an angle of approximately 90°, so that a circumferential, folded-down collar 30, as shown in FIG. 2, emanates from the piston main body 20. In the region of the folded-down collar 30, at least one ring groove 40 (in this case in the exemplary embodiment illustrated in FIG. 2, 3 ring grooves 40) is introduced at a given point in time. The piston main body 20 moreover has a piston lower part 50, so that a cooling duct 60 is created by the piston main body 20 along with the piston lower part 50 and the folded-down collar 30.

The forming of the collar 30 leads to a drawing closer or contact between the circumferential lower edge of the collar 30 and the upper side of the piston lower part 50 in the region of a dividing plane 70. The regions corresponding to one another of the collar 30 and the piston lower part 50 either form a gap in the region of the dividing plane or, as shown in FIG. 2, they come into contact in this region of the dividing plane 70 (small gap shown in FIG. 2 for purposes of illustration only).

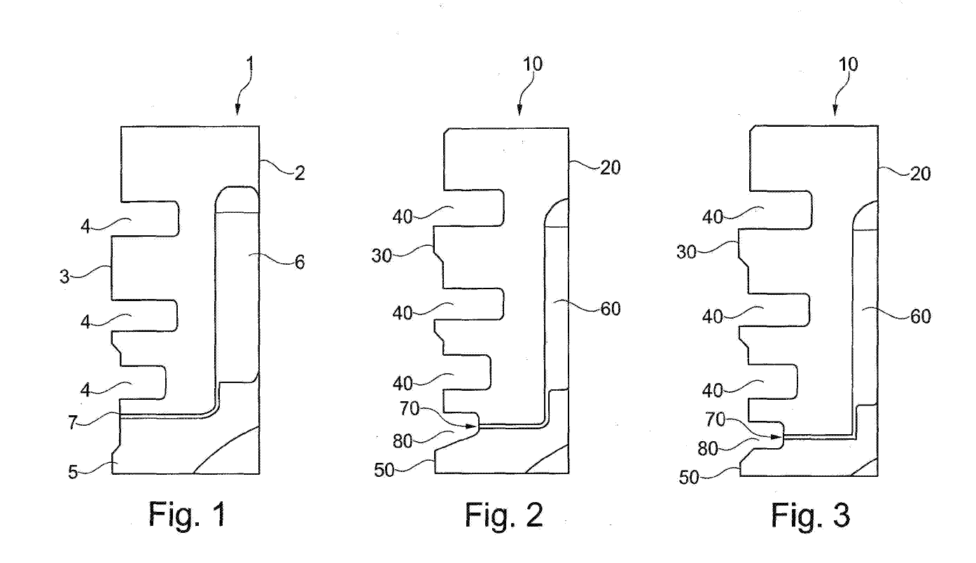

Unlike in the case of the aforementioned exemplary embodiment according to FIG. 1, in which the dividing plane 7 lay either in a ring groove 4 having a piston ring or below the lowermost ring groove 4, according to the exemplary embodiment and according to the invention the dividing plane 70 is placed in the region of a ring-free groove 80. This ring-free groove 80 is created by forming the lower circumferential edge of the collar 30 and the corresponding upper side of the piston lower part 50 and/or is introduced by a corresponding machining step, in particular a chip-removing machining process. Consequently, the detail of the cooling duct piston 10, as depicted in FIG. 2, shows in principle a cooling duct piston 10 which is for the most part finished and ready for use (while it should be emphasized that reworking has taken place in order to bring the cooling duct piston 10 up to the required standard).

Consideration can also be given, however, to a further substance-bonding joining process in the region of the dividing plane 70, such as, for example, a welding process. In order to illustrate this further machining step, reference is made to FIG. 3. It is assumed that the cooling duct piston 10 adopts the state depicted in FIG. 2 following the forming of the collar 30. The substance-bonded joining process then takes place in the region of the ring-free groove 80 (based on FIG. 2), wherein a welding bead produced during this is not depicted. In a further process step, this welding bead is removed (and, if not already present, the ring-free groove 80 is introduced), so that the cooling duct piston 10 in the region of the ring-free groove 80 adopts the form depicted in FIG. 3. There is then a final reworking of the cooling duct piston 10 supplied in this way, in order to bring it up to the standard required for it to be installed in a cylinder of an internal combustion engine.

Finally, FIGS. 4 and 5 show a finished cooling duct piston 10 of this kind which is ready for operation. It can be seen that this cooling duct piston 10 has the cooling duct 60 in a piston crown 90 (and possibly, as depicted, a combustion bowl), wherein the piston crown 90 is adjoined in a manner known per se by the piston lower part 50 with piston bosses 100, pin bores 110 and piston skirts 120. Reference number 130 is used to denote a piston stroke axis, wherein perpendicularly thereto a pin bore axis not referred to in greater detail runs through the pin bores 110.

“Ring groove” should be understood to mean a circumferential groove which is located in a ring field of the cooling duct piston and into which a piston ring (for example, an oil ring) is inserted.

The “outer circumferential edge” of the circumferential collar should, in particular, be understood to mean the face which points radially outwards before the forming of the collar projecting from the piston main body and which, following its forming, points downwards (in the direction of the piston skirt) when observing the piston stroke axis.

### LIST OF REFERENCE NUMBERS

1. Cooling duct piston

2. Piston main body

3. Circumferential collar

4. Ring groove

5. Piston lower part

6. Cooling duct

7. Dividing plane

10. Cooling duct piston

20. Piston main body

30. Circumferential collar

40. Ring groove

50. Piston lower part

60. Cooling duct

70. Dividing plane

80. Ring-free groove

90. Piston crown

100. Piston boss

110. Pin bore

120. Piston skirt

130. Piston stroke axis

1. A method for producing a cooling duct piston for an internal combustion engine, which cooling duct piston has a cooling duct in a piston crown, wherein the piston crown is adjoined by a piston lower part having piston bosses, pin bores and piston skirts, wherein a piston main body is firstly produced with a collar which is circumferential and projects radially in the region of the piston crown, wherein the collar is formed in such a manner until an outer circumferential edge is positioned in one of very closely or completely into contact with a bearing region of the piston lower part, in order to form the cooling duct, and subsequently at least one ring groove is formed in the collar, characterized in that a ring-free groove is formed in the collar below the at least one ring groove, wherein a dividing plane lies in the ring-free groove between the outer circumferential edge of the formed collar and an upper side of the piston lower part.

2. The method of claim 1, wherein the outer circumferential edge is positioned very closely to the bearing region, and wherein the collar is configured and formed in such a manner that in the region of the dividing plane between the outer circumferential edge of the formed collar and an upper side of the piston lower part a gap is created.

3. The method of claim 1, wherein the collar is configured and formed in such a manner that in the region of the dividing plane the outer circumferential edge of the formed collar comes into contact with the upper side of the piston lower part.

4. The method of claim 1, wherein the ring-free groove is formed by a chip-removing machining process.

5. The method of claim 1, wherein the ring-free groove is formed by a non-cutting machining process.

6. The method of claim 1, wherein the ring-free groove is created by a forming of the outer circumferential edge of the formed collar and an upper side of the piston lower part.

7. The method of claim 6, wherein the step of creating the ring-free groove further comprises a subsequent chip-removing machining process.

8. The method of claim 1, wherein in the region of the dividing plane between the outer circumferential edge of the formed collar and an upper side of the piston lower part, a joining process is carried out.

9. The method of claim 8, wherein the joining process comprises one of a welding process, a soldering process, or a bonding process.

10. The method of claim 9 wherein the joining process comprises the welding process forming a welding bead, wherein the method further comprises removing the welding bead.

11. A method for producing a cooling duct piston for use in an internal combustion engine, the method comprising:
forming a piston main body comprising:
a collar including a radial outer circumferential edge;
a lower part having an upper side;
a piston stroke axis;
further forming the collar to position the outer circumferential edge to one of directly adjacent to the lower part upper side or in direct contact with the lower part upper side defining a dividing plane and forming a cooling duct;
forming a ring groove in the collar operable to receive a piston ring;
forming a non-ring groove at the dividing plane positioned below the ring groove in a direction parallel to the piston stroke axis.

12. The method of claim 11 wherein the circumferential edge is directly adjacent to the lower part upper side defining a spatial gap between the collar outer circumferential edge and the lower part upper side, the gap in fluid communication with the cooling duct.

13. The method of claim 12 further comprising:
joining the collar outer circumferential edge to the lower part upper side at the dividing plane.

14. The method of claim 13 wherein the step of joining comprises one of welding, soldering or bonding.

15. The method of claim 14 wherein the step of joining comprises welding, the method comprising forming a weld bead within the non-ring groove.

16. The method of claim 11 further comprising:
joining the collar outer circumferential edge to the lower part upper side at the dividing plane.

17. The method of claim 11 wherein the step of forming the non-ring groove comprises one of a chip-removing machining, non-cutting machining or forming of the other circumferential edge of the formed collar and the lower part upper side.
